(19) United States
(12) Patent Application Publication
(10) Pub. No.: US 2015/0112636 A1
(43) Pub. Date: Apr. 23, 2015

(54) SYSTEMS AND METHODS FOR FORECASTING USING CARTESIAN GENETIC PROGRAMMING

(71) Applicant: Caterpillar Inc., Peoria, IL (US)

(72) Inventors: Anthony James GRICHNIK, Eureka, IL (US); Tatiana KALGANOVA, South Bucks (GB)

(73) Assignee: Caterpillar Inc., Peoria, IL (US)

(21) Appl. No.: 14/060,765

(22) Filed: Oct. 23, 2013

(51) Int. Cl. G06F 17/18; G06N 3/12

(52) U.S. Cl. CPC G06F 17/18; G06N 3/126
USPC 702/180

(57) ABSTRACT

A computer-implemented method is disclosed for forecasting characteristics of a target item. The method may include collecting a plurality of forecasting equations, decomposing each of the plurality of forecasting equations into one or more building blocks, and creating a population table consisting of a plurality of candidate equations each including one or more of the building blocks. The method may also include evolving the candidate equations in the population table by implementing a genetic algorithm based on historical characteristic data of the target item over a period of time until a convergence criterion is satisfied. The method may further include selecting an equation from the plurality of candidate equations in the population table that best fits the historical characteristic data over the period of time, and forecasting the characteristics of the target item by using the selected equation.

### TECHNICAL FIELD

This disclosure relates generally to forecasting methods and, more particularly, to forecast characteristics of a target item using Cartesian genetic programming.

### BACKGROUND

Organizations, such as those that produce, buy, sell, and/or lease products, may desire to forecast information concerning a product. For example, an organization that manufactures one or more products may desire to accurately forecast the demand for the product, the organization's production schedule for the product, and/or a supplier's delivery schedule for subcomponents of the product. Moreover, when developing forecast information for a product, an organization may desire to have the forecast information take into account one or more business goals related to the organization.

U.S. Pat. No. 7,213,007 (the '007 patent) to Grichnik is directed to forecasting characteristics of a product using a genetic algorithm. In particular, the '007 patent discloses a forecasting method including determining one or more equations associated with forecasted characteristics of a target item, implementing a genetic algorithm to determine data values for a plurality of variables in the one or more equations, and forecasting the characteristics of the target item by solving the one or more equations using the determined data values for the variables. While the '007 patent may help to generate statistically accurate representations of the historical data, the method of the '007 patent assumes that the structures of the one or more equations are always known. However, in some applications, the structures of the one or more equations may not always be self evident at the time the forecast is to be produced.

The disclosed methods and systems are directed to solving one or more of the problems set forth above and/or other problems of the prior art.

### SUMMARY

In one aspect, the present disclosure is directed to a computer-implemented method for forecasting characteristics of a target item. The method may include collecting a plurality of forecasting equations, decomposing each of the plurality of forecasting equations into one or more building blocks, and creating a population table consisting of a plurality of candidate equations each including one or more of the building blocks. The method may also include evolving the candidate equations in the population table by implementing a genetic algorithm based on historical characteristic data of the target item over a period of time until a convergence criterion is satisfied. The method may further include selecting an equation from the plurality of candidate equations in the population table that best fits the historical characteristic data over the period of time, and forecasting the characteristics of the target item by using the selected equation.

in another aspect, the present disclosure is directed to a system for forecasting characteristics of a target item. The system may include a processor and a memory module. The memory module may be configured to store instructions, that, when executed, enable the processor to collect a plurality of forecasting equations, decompose each of the plurality of forecasting equations into one or more building blocks, create a population table consisting of a plurality of candidate equations each including one or more of the building blocks, evolve the candidate equations in the population table by implementing a genetic algorithm based on historical characteristic data of the target item over a period of time until a convergence criterion is satisfied, select an equation from the plurality of candidate equations in the population table that best fits the historical characteristic data over the period of time and forecast the characteristics of the target item by using the selected equation.

In yet another aspect, the present disclosure is directed to a non-transitory computer-readable storage device. The storage device may store instructions fur forecasting characteristics of a target item. The instructions may include collecting a plurality of forecasting equations, decomposing each of the plurality of forecasting equations into one or more building blocks, creating a population table consisting of a plurality of candidate equations each including one or more of the building blocks, evolving the candidate equations in the population table by implementing a genetic algorithm based on historical characteristic data of the target item over as period of time until a convergence criterion is satisfied, selecting an equation from the plurality of candidate equations in the population table that best fits the historical characteristic data over the period of time, and forecasting the characteristics of the target item by using the selected equation.

### BRIEF DESCRIPTION OF THE DRAWINGS

FIG. 1 is a diagrammatic illustration of an exemplary forecasting system that may be configured to perform certain functions consistent with disclosed embodiments;

FIG. 2 is a flowchart illustrating an exemplary forecasting process consistent with disclosed embodiments;

FIG. 3 illustrates an exemplary table including historical data consistent with disclosed embodiments;

FIG. 4 illustrates a table including exemplary forecasting equations consistent with disclosed embodiments;

FIG. 5 illustrates a table including exemplary building blocks consistent with disclosed embodiments;

FIG. 6 illustrates an exemplary population table consistent with disclosed embodiments;

FIG. 7 illustrates an exemplary encoding map consistent with disclosed embodiments;

FIG. 8 illustrates an exemplary encoding process consistent with disclosed embodiments;

FIG. 9 illustrates a flowchart of an exemplary forecasting process consistent with the disclosed embodiments; and

FIG. 10 is a graph that represents best fitness values versus numbers of evolutions obtained by an incremental evolution process consistent with the disclosed embodiments.

### DETAILED DESCRIPTION

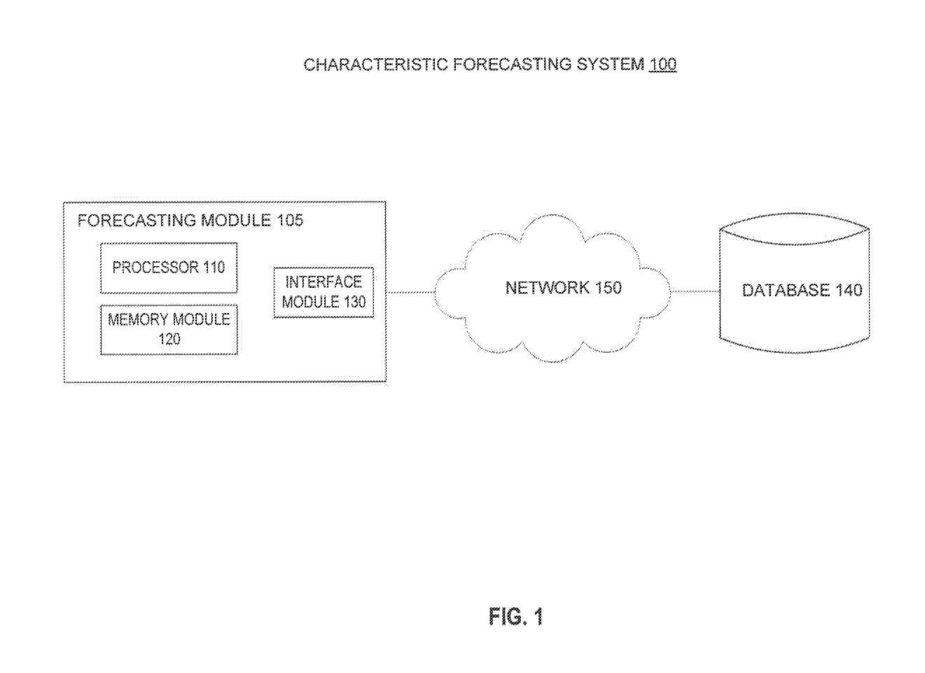

FIG. 1 illustrates an exemplary characteristic forecasting system 100 in which features and principles consistent with disclosed embodiments may be implemented. As shown in FIG. 1, characteristic forecasting system 100 may include a plurality of modules that perform various functions consistent with certain features related to the disclosed embodiments. In one embodiment, characteristic forecasting system 100 may include a forecasting module 105 and a database 140 connected via a network 150.

Forecasting module 105 may be a computing system that performs various functions consistent with certain embodiments. In one embodiment, forecasting module may be configured to forecast the demand for selected products used on historical production activities or other historical data, such as product history data. Forecasting module 105 may include a processor 110, a memory module 120, and an interface module 130. Processor 110 may include one or more processor devices known in the art, such as a. microprocessor, microcontroller, laptop computer, desktop computer, workstation, mainframe, etc. Memory module 120 may include one or more storage devices configured to store information that is used by processor 110 and/or other entities internal and external to forecasting module 105. For example, memory module 120 may store one or more characteristic forecast programs that, when executed, enable processor 110 to forecast characteristics (e.g., demand) of a target item (e.g., a product), consistent with disclosed embodiments. Interface module 130 may be one or more devices that facilitate the transfer of information between forecasting module 105 and external components, such as database 140 and/or one or more user devices (not shown).

A product, as used herein, may represent any type of physical good that is designed, developed, manufactured, and/or delivered by a source, such as, for example, a manufacturer or a distributor. The product may also represent replacement parts and/or service parts for existing products, components, or sub-components. Moreover, those skilled in the art will appreciate that a product may represent other types of goods, such as a non-physical object (e.g., stocks, bonds, financial commodities, etc.) that may be generated, obtained, delivered, bought, and/or sold. A target item, as used herein, may represent a tangible object, such as a product. Alternatively, a target item may represent a non-physical product (e.g., stocks, bonds, financial commodities, etc.) or other non-tangible items, such as mathematical representations (e.g., vibration analysis data). Although the forecasting processes discussed below will be described with respect to a product manufactured by a business entity, those skilled in the art will appreciate that the following description may apply to any type of target item.

Database 140 may represent one or more storage devices that store information used by forecasting module 105 to perform certain functions consistent with disclosed embodiments, in one embodiment, database 140 stores product history data. Product history data stored in database 140 may include previous production data for a product, such as a number of products demanded, ordered, sold, manufactured, and/or shipped over a period of time (T) in selected intervals (e.g., days, weeks, months, quarters, years, etc.). Further, the product history data may represent the number of units of the product available during a certain stage of manufacture, such as a molding stage, an engine placement stage, etc. Product history data stored in database 140 may also include historical data regarding components of products, such as data indicating a number of components for a product that have been received from a supplier at selected time intervals. The selected intervals of time t may represent, for example, equal periods of time over which the products are monitored.

Database 140 may also store financial data related to products. For example, database 140 may store information such as the sales price per unit, production cost per unit, profit margin per unit, unit carrying cost, etc., related to one or more products. Database 140 may also store information related to inventory levels of one or more products, such as a current inventory level, maximum inventory level, minimum inventory level, etc., of one or more products. Moreover, database 140 may store information such as a maximum number of products that may be produced in a given time interval (e.g., # of units/time interval), a maximum velocity with which production may be ramped up (e.g., # of units/time interval²), or a maximum acceleration with which production may be ramped up (e.g., # of units/time interval³). Further, database 140 may store any other information that may be used by forecasting module 105 in accordance with one or more of the embodiments discussed below.

Network 150 shown in FIG. 1 may include any one of or combination of wired or wireless networks. For example, network 150 may include wired networks such as twisted pair wire, coaxial cable, optical fiber, and/or a digital network. Likewise, network 150 may include any wireless networks such as REID, microwave or cellular networks or wireless networks employing, e.g., IEEE 802.11 or Bluetooth protocols. Additionally, network 150 may be integrated into any local area network, wide area network, campus area network, or the Internet.

Although FIG. 1 shows the configuration of processor 110, memory module 120, interface module 130, and database 140 as separate elements, those skilled in the art will appreciate that characteristic forecasting system 100 may be implemented in a number of different configurations consistent with disclosed embodiments. For example, processor 110, memory module 120, interface module 1.30, and database 140 may be combined into a single module that includes software, hardware, and/or a combination of both. Alternatively, characteristic forecasting system 100 may be configured as a distributed system, with processor 110, memory module 120, interface module 130, and database 140 distributed in remote locations and interconnected by communication paths, such as Local Area Networks (LANs), Wide Area Networks (WANs), and any other type of network that may facilitate communications and the exchange of information between the modules and/or any other elements that may be implemented by characteristic forecasting system 100. Also, characteristic forecasting system 100 may include additional or fewer modules than those depicted in FIG. 1.

In certain embodiments, forecasting module 105 may be an end-user device. In other embodiments, forecasting module 105 and database 140 may be connected to one or more end-user devices (not shown) via network 150. In these embodiments, an end-user at an end-user device may send data, such as product history data, financial data, inventory data, etc., to forecasting module 105 and/or database 140 via network 150. For example, the end-user device may include a web browser and/or other application that enables it to send information to forecasting module 105 and/or database 140 and request forecast data from forecasting module 105. Forecasting module 105 may then determine forecast data based on the data provided by the end-user device, e.g., according to one or more embodiments discussed below, and may then send the forecast data to the end-user device, e.g., via the browser or other application. According to these embodiments, the processing performed by forecasting module 105, according to one or more embodiments discussed below, may be performed “in the cloud” with respect to the end-user, and then the results of the processing (e.g., the forecast data representing a forecast of a characteristic of a target item) sent hack to the end-user. The owner or administrator of forecasting module 105 may Charge a fee of some sort to the one or more end-users for using the forecasting services provided by forecasting module 105.

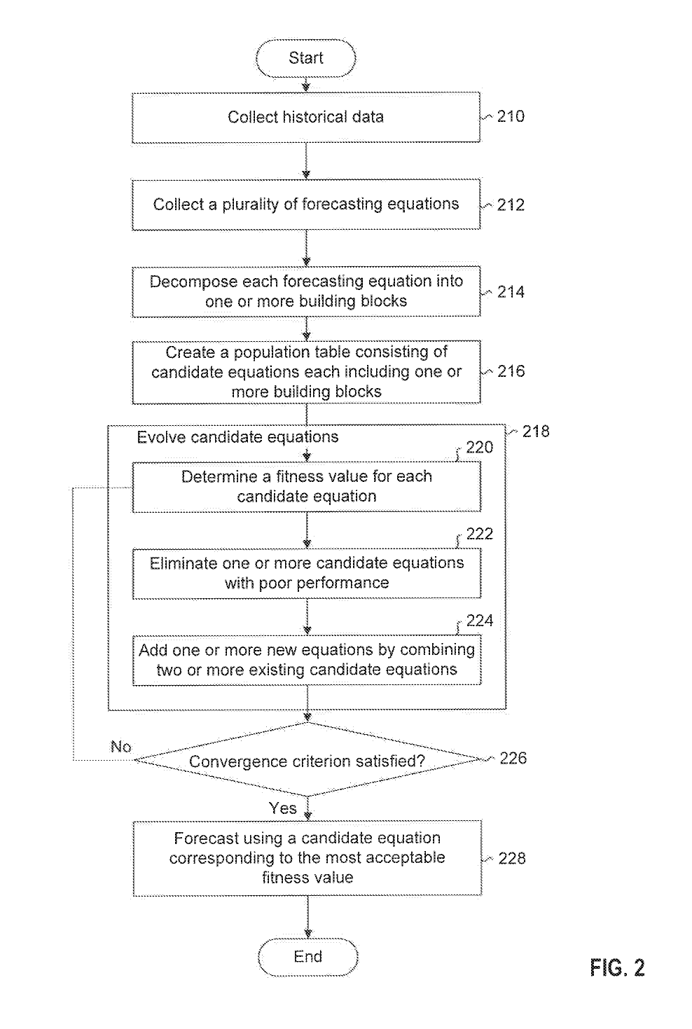

in certain embodiments, exemplary characteristic forecasting system 100 may be configured to determine a forecast function that produces forecast data with a estimable level of accuracy at a given time in the future. FIG. 2 illustrates a flowchart of an exemplary forecasting process that may be performed by characteristic forecasting system 100. As shown, forecasting module 105 may begin with collecting historical data associated with the characteristics of a target item that is to be forecasted (step 210).

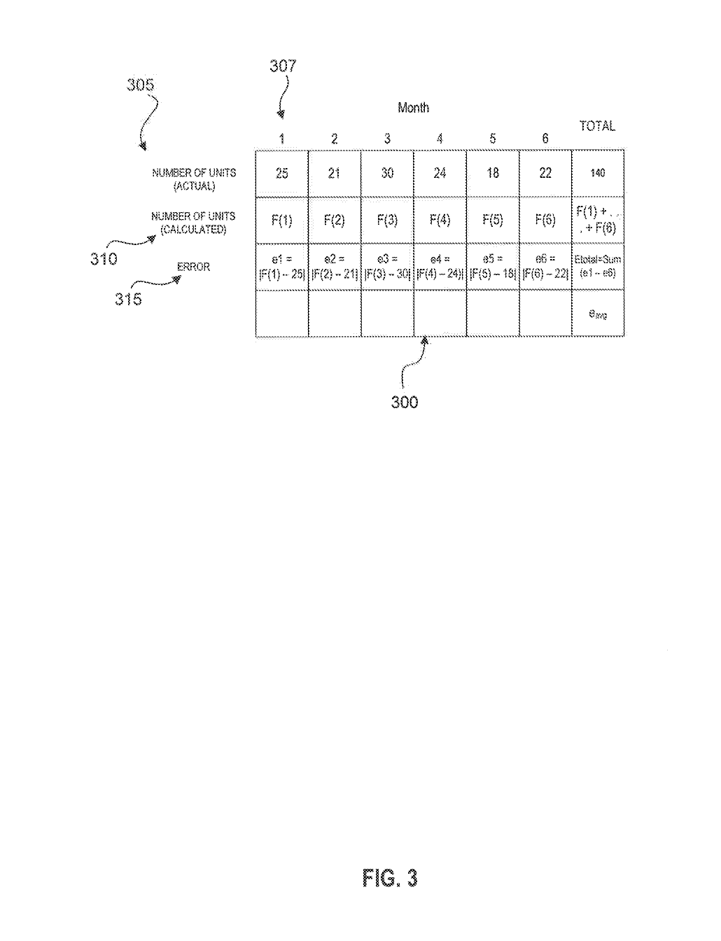

Characteristics, as used herein, may represent any type of attribute associated with a target item. For example, characteristics may include manufacturing, developing, design, ordering, sale, purchase, and shipping numbers associated with the target item. In one embodiment, forecasting module 105 may collect data, such as the data discussed above, associated with a product from database 140. As discussed, the data may be arranged to represent values, such as a number of units of a product demanded, ordered, sold, manufactured, and/or shipped over a predetermined period of time (T) in selected intervals (e.g., days, weeks, months, quarters, years, etc.). In this example, the historical data collected by forecasting module 105 may represent the number of units of a product manufactured for each month over a period of six. months. Therefore, time period T is equal to six (6). FIG. 3 shows a non-limiting example of a table 300 including the number of products manufactured over a period (I) of six months. As shown, table 300 may include an exemplary number of actual units manufactured 305 for each of a plurality of months 307 that make up the time period T. Of course, table 300 may alternatively or additionally include an exemplary number of actual units demanded, ordered, shipped, sold, etc., consistent with disclosed embodiments.

Referring back to FIG. 2, in addition to collecting historical data, forecasting module 105 may collect a plurality of forecasting equations for forecasting the characteristics of the target item (step 212). In one embodiment, the forecasting equations may be inputted by a user and may be stored in database 140, and forecasting module 105 may collect the forecasting equations from database 140.

The forecasting equations collected by forecasting module 105 may be equations used in different forecasting techniques for forecasting the characteristics of the target item. In one embodiment, the forecasting equations may be time series forecasting equations for forecasting demand quantities of a product. The time series forecasting equations may include at least equations 411 through 417 represented as follows:

$$\begin{matrix}{σ}_{t}^{2} = {α}_{0} + {\sum }_{i = 1}^{q} {α}_{i} {ɛ}_{t - 1}^{2} & Equation 411 \\ {σ}_{t}^{2} = {α}_{0} + {\sum }_{j = 1}^{p} {β}_{j} {σ}_{t - j}^{2} + {\sum }_{i = 1}^{q} {α}_{i} {ɛ}_{t - i}^{2} & Equation 412 \\ {σ}_{t}^{2} ≅ K + {\sum }_{i = 1}^{p} {G}_{i} {σ}_{t - i}^{2} + {\sum }_{j = 1}^{q} {A}_{j} {{σ}_{t - i}^{2} [ \frac{{ɛ}_{t - j}^{2}}{\sqrt{{σ}_{t - i}^{2}}} - {C}_{j} ]}^{2} & Equation 413 \\ {σ}_{t}^{2} = ω + {βσ}_{t - i}^{2} + {αɛ}_{t - i}^{2} & Equation 414 \\ {σ}_{t}^{2} = ω + {βσ}_{t - i}^{2} + Φ ( 1 + α ) {ɛ}_{t - i}^{2} & Equation 415 \\ {y}_{t} = {\sum }_{i = 1}^{p} {φ}_{i} {y}_{t - i} + {\sum }_{s = 1}^{q} {θ}_{s} {ɛ}_{t - s} & Equation 416 \\ {y}_{t} = {α}_{0} + {\sum }_{i = 1}^{p} {β}_{i} {y}_{t - i} - {\sum }_{i = 1}^{q} {α}_{j} {ɛ}_{t - i} & Equation 417\end{matrix}$$

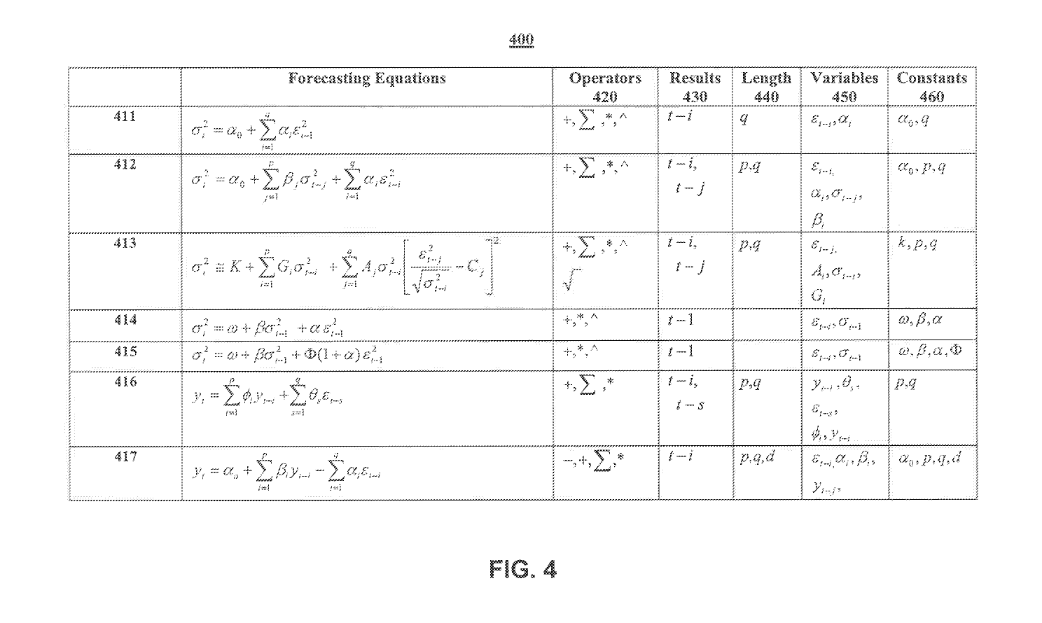

FIG. 4 illustrates a table 400 including the above listed time series equations 411 through 417, and their respective primitive operators 420, output results 430, lengths 440, variable 450, and constants 460. In other embodiments for forecasting different characteristics of a target item, for example for predicting vibrations of a signal transmitted through a medium, the forecasting equations may be different than equations 411 through 417. Those skilled in the art will appreciate that other equations in other types of forecasting techniques may be collected by forecasting module 105.

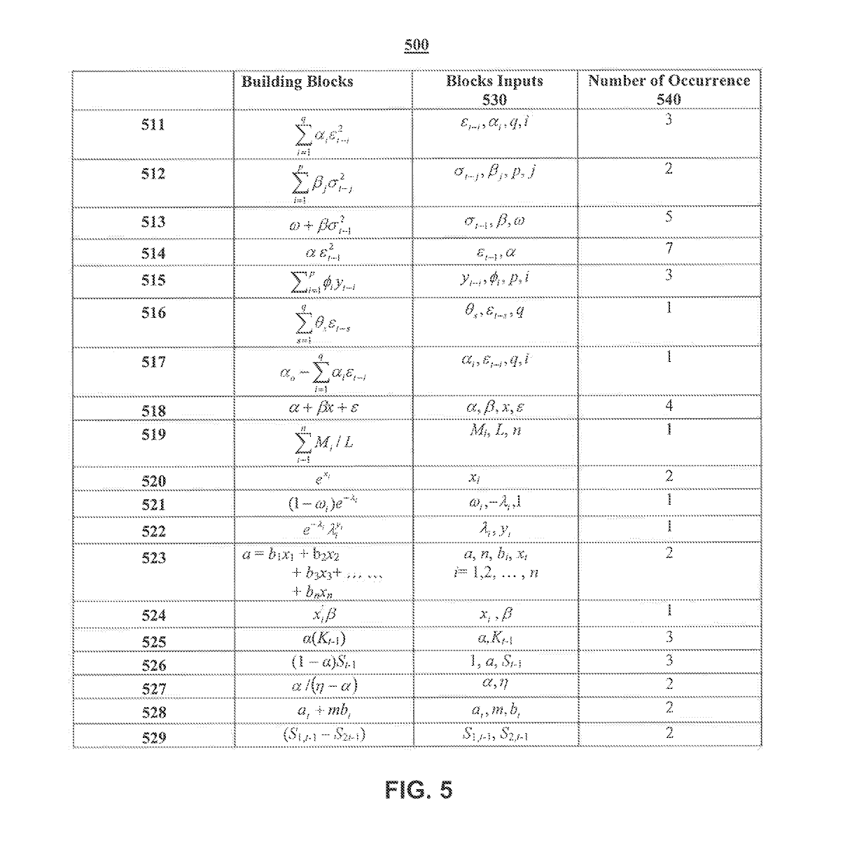

Referring back to FIG. 2, after collecting the plurality of forecasting equations, forecasting module 105 may decompose each of the plurality of forecasting equations into one or more building blocks (step 214). FIG. 5 illustrates a table 500 including building blocks 511 through 529, and their respective block inputs 530, and number of occurrence 540, obtained by decomposing equations 411 through 417 listed in table 400. For example, forecasting module 105 may decompose equation 411 into a building block 511 represented by

$${\sum }_{i = 1}^{q} {α}_{i} {ɛ}_{t - i}^{2} .$$

Similarly, forecasting module 105 may decompose equation 412 into building blocks 512 and 511 represented by

$${\sum }_{j = 1}^{p} {β}_{j} {σ}_{t - j}^{2} and {\sum }_{i = 1}^{q} {α}_{i} {ɛ}_{t - i}^{2} ,$$

respectively. Forecasting module 105 may store building blocks 511 through 529 in database 140.

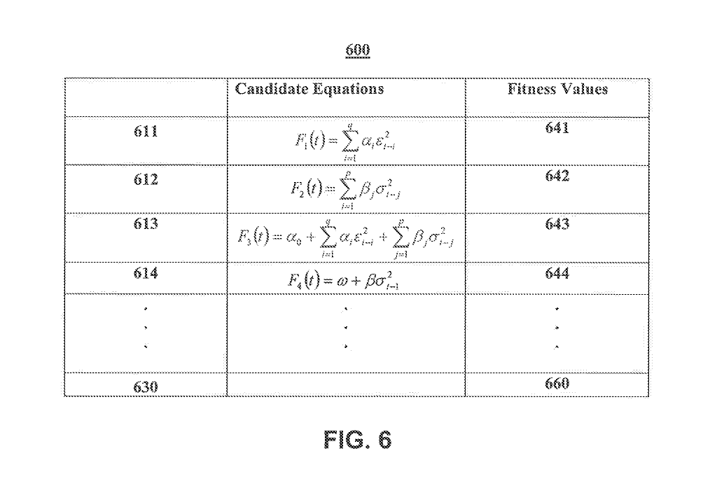

Following step 214, forecasting module 105 may create a population table consisting of a plurality of candidate equations each including one or more of the building blocks (step 216). FIG. 6 illustrates an exemplary population table 600 consistent with disclosed embodiments. Population table 600 may include candidate equations 611 through 630, and their respective fitness values 641 through 660 determined based on the collected historical data. Each of candidate equations 611 through 630 may include one or more of building blocks 511 through 529 listed in table 500. In some embodiments, a candidate equation may additionally include some standard mathematical operators such as “+”, “−”, “x”, and “/”, etc., and some constants, in addition to the one or more building blocks. The determination of fitness values 641 through 660 and the method by which the candidate equations are constructed from the building blocks in table 500 will be described in further detail in the following paragaphs.

As illustrated in FIG. 6, candidate equation 611 represented by

$$F ( t ) = {\sum }_{i = 1}^{q} {α}_{i} {ɛ}_{t - i}^{2}$$

may include building block 511 represented by

$${\sum }_{i = 1}^{q} {α}_{i} {ɛ}_{t - i}^{2} ;$$

candidate equation 612 represented by

$$F ( t ) = {\sum }_{i = 1}^{p} {β}_{j} {σ}_{t - j}^{2}$$

may include building block 512 represented by

$${\sum }_{i = 1}^{p} {β}_{j} {σ}_{t - j}^{2} ;$$

candidate equation 613 represented by

$$F ( t ) = {α}_{0} + {\sum }_{i = 1}^{q} {α}_{i} {ɛ}_{t - i}^{2} + {\sum }_{j = 1}^{p} {β}_{j} {σ}_{t - j}^{2}$$

may include building blocks 511 and 512, a constant α₀, and three mathematical operators “+”; and candidate equation 614 represented by F(t)=ω+βσₜ₋₁² may include building block 513 represented by ω+βσₜ₋₁². Although population table 600 illustrated in FIG. 6 includes twenty (20) candidate equations, those skilled in the art will appreciate that population table 600 may include various numbers (e.g., 10-100) of candidate equations appropriate to the complexity of the item being studied.

In some embodiments, after creating population table 500 but before it is filled with candidate equations, forecasting module 105 may perform an encoding process to encode each of the candidate equations via a numeric string representing the combination of arithmetic operators, building blocks, and constants that constitute the candidate equation. The collection of these elements may be referred to as a chromosome. The encoding process creates a candidate equation through a plurality of gates, each including a single mathematical operator, and encoding each gate into a unit string based on a predetermined encoding scheme using an encoding map, then concatenating the unit strings to generate the numeric string, i.e., the chromosome, representing the candidate equation.

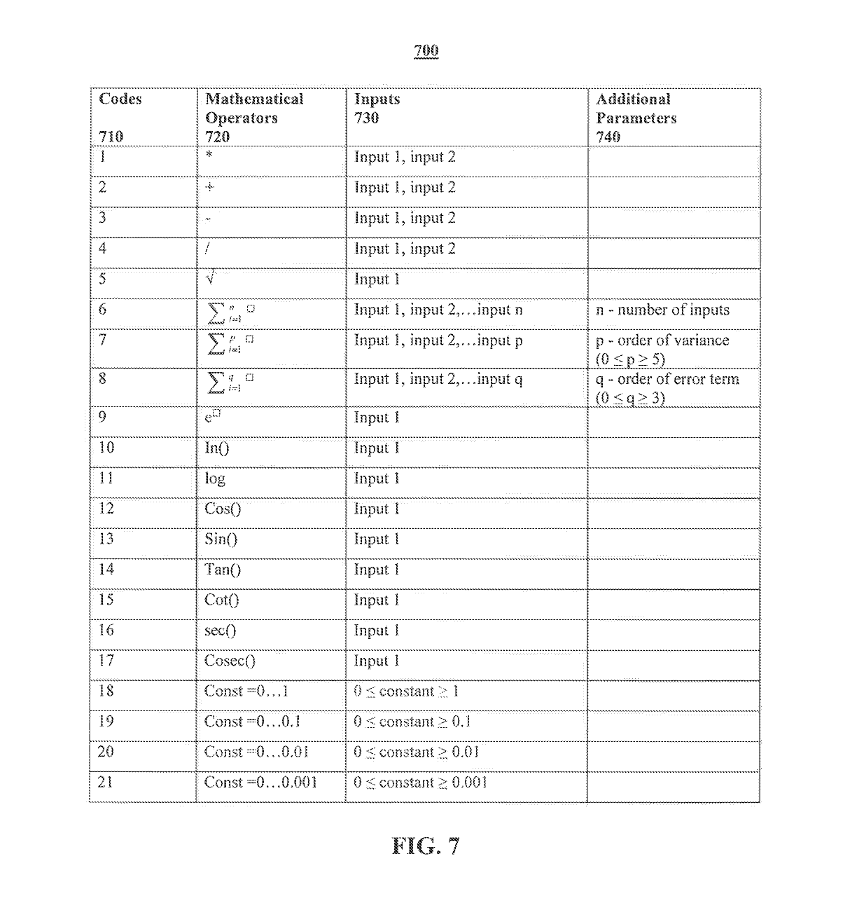

FIG. 7 illustrates an exemplary encoding map 700 consistent with disclosed embodiments. As illustrated in FIG. 7, encoding map 700 includes a plurality of codes 710, and their respective mathematical operators 720, inputs 730, and additional parameters 740. For example, mathematical operator “x” may be encoded as “1”, and may be associated with two inputs. Similarly, mathematical operator “+” may be encoded as “2”, and may be associated with two inputs.

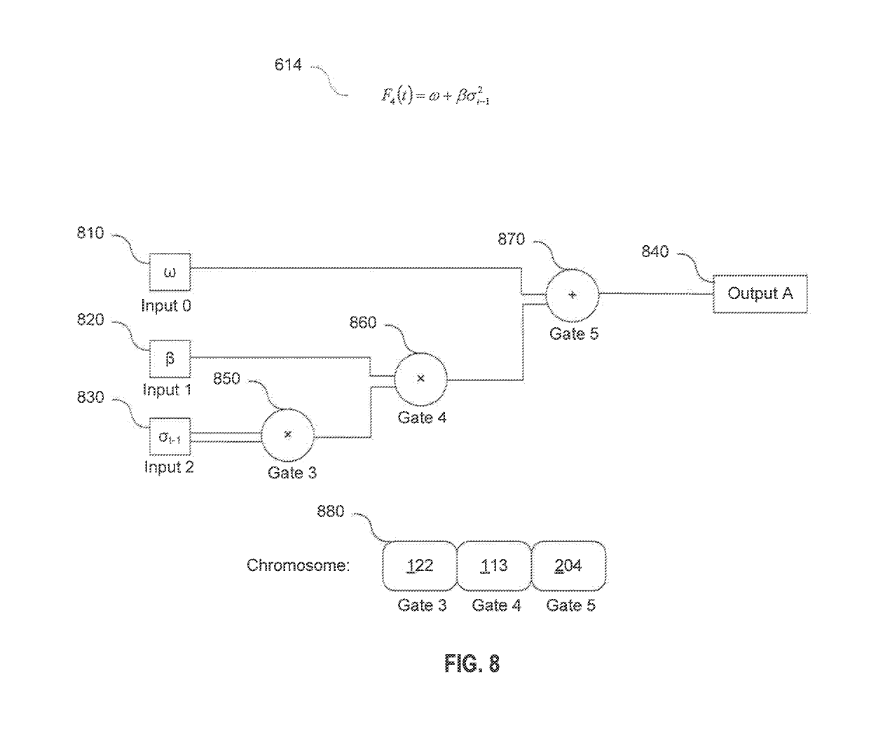

FIG. 8 illustrates an exemplary encoding process for candidate equation 614 consistent with disclosed embodiments. As illustrated in FIG. 8, candidate equation 614 represented by F(t)=ω30βσₜ₋₁² may include three (3) inputs 810, 820, and 830 represented by ω, β, and σₜ₋₁, respectively, and one output 840 represented by F(t). Candidate equation 614 may also include three (3) gates 850, 860, and 870 represented by “x”, “x”, and “+”, respectively, Based on the interconnections between inputs 810, 820, and 830, output 840, and gates 850, 860, and 870, an output of gate 850 may be represented by σₜ₋₁²; an output of gate 860 may be represented by βσₜ₋₁²; and an output of gate 870 may be represented by ω+βσₜ₋₁², which corresponds to output 840. Based on the predetermined encoding scheme, inputs 810, 820, and 830 may be encoded as “0”, “1”, and “2”, respectively. The mathematical operators “x”, “x”, and “+” in gates 850, 860, and 870 may be encoded as “1”, “1”, and “2”, respectively, according to encoding table 700. The predetermined encoding scheme may be set such that each mathematical gate may be encoded into a unit string consisting of three (3) digits, with the first digit representing the associated mathematical operator, and the second and third digits representing the associated two inputs. Therefore, according to the encoding scheme, gates 850, 860, and 870 may be encoded into unit strings represented by “122”, “113”, and “204”. Consequently, by concatenating the unit strings of mathematical gates 850, 860, and 870, candidate equation 614 may be encoded into a chromosome 880 represented by “122113204”.

Referring back to FIG. 2, after creating population table 600 in step 216, forecasting module 105 may perform an evolutionary process 218 to evolve candidate equations 611 through 630 in population table 600. For example, forecasting module 105 may evolve candidate equations 611 through 630 by implementing a genetic algorithm based on the historical data collected in step 210.

Specifically, evolutionary process 218 may begin with determining a fitness value for each candidate equation (step 220). A. fitness value of a candidate equation may be determined based on a fitness function that assesses the fitness of the candidate equation with respect to the collected historical data over a period of time. In certain embodiments, the fitness function may be an error-based fitness function that determines how close calculated values calculated with the corresponding candidate equation are to actual values in the historical data collected in step 210. In one embodiment, the error-based fitness function (FF) may be represented by:

FFₑᵣᵣₒᵣ=e_{avg}*(eₘₐₓ)ⁿ

where e_{avg} is the average error between the calculated values and the actual values for the candidate equation across multiple time intervals in the historical data, eₘₐₓ is the maximum single point error between the calculated and actual values across multiple time intervals in the historical data, and n is an integer greater than zero (e.g., 1, 2, 3, etc.), The value of n may be determined by a user operating forecasting module 105 or may be determined by forecasting module 105 autonomously. Further, the value of n may be changed prior, during, or subsequent to the performance of the forecasting process by forecasting module 105.

To calculate the average error e_{avg}, forecasting module 105 may sum the error e(t) for each interval within time period T and divide the result by the time period T. To calculate the maximum single point error eₘₐₓ, forecasting module 105 may determine the maximum error amongst the errors determined for each interval within time period T. To determine the error for each interval, forecasting module 105 may calculate the data value of the candidate equation corresponding to each historical data value collected in step 210 (e.g., each month of table 300). For example, the data value of candidate equation 611 represented by

$$F ( t ) = {\sum }_{i = 1}^{q} {α}_{i} {ɛ}_{t - i}^{2}$$

for each month may be:

$$time interval t = 1 , F ( 1 ) = {\sum }_{i = 1}^{q} {α}_{i} {ɛ}_{1 - i}^{2}$$

$$time interval t = 2 , F ( 2 ) = {\sum }_{i = 1}^{q} {α}_{i} {ɛ}_{2 - i}^{2}$$

$$time interval t = 3 , F ( 3 ) = {\sum }_{i = 1}^{q} {α}_{i} {ɛ}_{3 - i}^{2}$$

$$time interval t = 4 , F ( 4 ) = {\sum }_{i = 1}^{q} {α}_{i} {ɛ}_{4 - i}^{2}$$

$$time interval t = 5 , F ( 5 ) = {\sum }_{i = 1}^{q} {α}_{i} {ɛ}_{5 - i}^{2}$$

$$time interval t = 6 , F ( 6 ) = {\sum }_{i = 1}^{q} {α}_{i} {ɛ}_{6 - i}^{2}$$

As illustrated in FIG. 3, the calculated data values for F(1) through F(6) (calculated number of units manufactured 310) may be used by forecasting module 105 to determine the error e(t) 315 for each month. For example, forecasting module 105 may determine the error e(t) by calculating the difference between the calculated data values F(t) (calculated number of units manufactured 310) and the actual data values ACTUAL(t) (actual number of units manufactured 305) fix each interval t in time period T. That is, for interval t,

e(t)=|F(t)−ACTUAL(t)|

Once the error e(t) for each interval t is determined, forecasting module 105 may then determine the average error e_{avg} by summing the error data values for each interval (e.g., months 1-6 in table 300) and dividing by the time period T (e.g., T=6 in table 300). That is, the average error e_{avg} may be represented by:

e_{avg}=SUM{e(1), e(2), . . . e(6)}/6

To determine the maximum single point error eₘₐₓ, forecasting module 105 may select the maximum error amongst the error e(t) determined for each interval within time period T. That is, the maximum single point error eₘₐₓ may be represented by:

eₘₐₓ=MAX{e(1), e(2), . . . e(6)}

In other embodiments, the fitness function may include both of the error-based fitness function FFₑᵣᵣₒᵣ and a quality-based fitness function FF_{quality} that takes into account a measure of one or more business goals. For example, the quality-based fitness function may take into account a measurement of one or more of profit, return on net assets (RONA), inventory turns, service level, or any other combination of business goals that may be calculated based on the historical data and/or forecast data, The quality-based fitness function FF_{quality} for a candidate equation over a period of time may be represented by:

$${FF}_{quality} = a ( \frac{Max Profit - Profit}{Max profit} ) + b ( \frac{Max RONA - RONA}{Max RONA} ) + c ( \frac{Max Turns - Turns}{Max Turns} ) + d ( \frac{Max Service Level - Service Level}{Max Service Level} )$$

wherein a, b, c, and d represent the relative weighting values for profit, RONA, inventory turns, and service level, respectively, and a+b+c+d 1. For example, a=0.125, b 0.25, c=0.125, and d=0.5. In the quality-based fitness function FF_{quality}, the Max Profit, Max RONA, Max Turns and Max Service Level represent the theoretical maximum profit, RONA, inventory turns, and service level that can be achieved over the period of time when all of the orders are fulfilled, respectively. In addition, the Profit, RONA, Turns, and Service Level in the quality-based fitness function represent the calculated profit, RONA, inventory turns, and service level by using the candidate equation over the period of time.

In one embodiment, the fitness function may be a weighted sum of the error-based fitness function FFₑᵣᵣₒᵣ and the quality-based fitness function FF_{quality}. That is, the fitness function may be represented by:

FF_{error&quality}=a·FFₑᵣᵣₒᵣ+b·FF_{quality}

where a and b represent the relative weighting values for the the error-based fitness function FFₑᵣᵣₒᵣ and the quality-based fitness function FF_{quality}, and a+b=1. For example, a=0.5, and b=0.5.

In certain embodiments, the fitness function discussed above may be used to determine the fitness value for the corresponding candidate equation. For example, the fitness value (FV) for candidate equation 611 in population table 600 may be equal to:

FV(candidate equation 611)=FF_{error&quality}(candidate equation 611)

Returning hack to FIG. 2, after determining a fitness value for each candidate equation, forecasting module 105 may eliminate one or more candidate equations with poor performance (step 222). In one embodiment, forecasting module 105 may sort population table 600 based on the determined fitness values, and eliminate a certain percentage (e.g., 10-30%) of the candidate equations from the bottom of the sorted population table. Forecasting model 105 may sort the population table in ascending or descending order based on the fitness function being used and whether the forecasting process is attempting to minimize or maximize the fitness value. For example, if the forecasting process is attempting to minimize the fitness value, a candidate equation having a relatively low fitness value may be a relative good choice. In this case, forecasting module 105 may sort the population table in ascending order of the fitness values. The fitness function FF_{error&quality} described above corresponds to this case in which the forecasting process is attempting to minimize the fitness value, and therefore forecasting module 105 may sort the population table in ascending order of the fitness values determined based on the fitness function FF_{error&quality}. On the other hand, if the forecasting process is attempting to maximize the fitness value, a candidate equation having a relatively high fitness value may be a relative good choice. In this case, forecasting module 105 may sort the population table in descending order of the fitness value.

In another embodiment, forecasting module 105 may determine a plurality of business values for each candidate equation in population table 600, and may eliminate a predetermined percentage of the candidate equations that have one or more of the business values inferior to the other candidate equations. The business values may include at least one of profit, RONA, inventory turns, and service level. For example, forecasting module 105 may determine profit, RONA, inventory turns, and service level associated with each candidate equation over period T. Since the forecasting process is attempting to maximize each of profit, RONA, inventory turns, and service level, forecasting module 105 may sort population table 600 in descending order based on each of the business values, to generate a first sorted population table sorted in descending order of profit, a second sorted population table sorted in descending order of RONA, a third sorted population table sorted in descending order of inventory turns, and a fourth population table sorted in descending order of service level. Then, forecasting module 105 may eliminate one or more candidate equations that are located at the bottom portion of each one of the first through fourth sorted population table.

Following step 222, forecasting module 105 may add one or more new candidate equations generated by implementing a genetic operation (step 224). For example, forecasting module may add back a certain percentage (e.g. 10-30%) of new candidate equations generated by the genetic operation based on the existing candidate equations in population table 600. In one embodiment, a new candidate equation may be generated by a crossover operation for combining at least a part of two or more of the existing candidate equations. In another embodiment, a new candidate equation may be generated by a mutation operation for randomly mutating at least a part of an existing equation. Those skilled in the art would appreciate that other genetic operations may be utilized in generating the new candidate equations.

Following evolutionary process 218, forecasting module 105 may determine whether a convergence criterion has been satisfied (step 226). For example, forecasting module 105 may determine whether the fitness values of the candidate equations in population table 600 have converged. In order to do so, forecasting module 105 may first determine the fitness values of the candidate equations in the current population table 600 after evolutionary process 218, and select a best fitness value amongst all of the fitness values. In the above example of fitness function FF_{error&quality} in which the forecasting process is attempting to minimize the fitness value, forecasting module 105 may select a minimum fitness value amongst all of the fitness values as the best fitness value. Forecasting module 105 may then compare the best fitness value with a previous best fitness value of the previous population table before evolutionary process 218. Next, forecasting module 105 may determine whether the best fitness value has improved from the previous best fitness value. In the above example in which the forecasting process is attempting to minimize the fitness value, forecasting module 105 may determine whether the best fitness value is smaller than the previous best fitness value, and if the best fitness value is smaller than the previous best value, the best fitness value has improved. Then, forecasting module 105 may determine whether the improvement of the best fitness value over the previous best fitness value falls below a predetermined threshold value. if the improvement falls below the predetermined threshold value, forecasting module 105 may determine that the fitness values of the candidate equations in population table 600 have converged, and the convergence criterion is satisfied. If forecasting module 105 determines that the best fitness value has improved, but the improvement of the best fitness value over the previous best fitness value does not fall below the predetermined threshold value, that is, the convergence criterion is not satisfied either (step 226, No), forecasting module 105 may repeat evolutionary process 218 based on the candidate equations in the current population table.

In some embodiments, the best fitness value may not improve over the priovious best fitness value. In such case, the convergence criterion is also not satisfied (step 226, No). Then, forecasting module 105 may repeat evolutionary process 218 based on the candidate equations in the previous population table before the evolutionary process.

If forecasting module 105 determines that the convergence criterion is satisfied (step 226, Yes), forecasting module 105 may forecast the characteristic of the target item by using a candidate equation corresponding to the most acceptable fitness value (step 228). In one embodiment, forecasting module 105 may select an equation from the plurality of candidate equations in population table that best fits the historical Characteristic data over the period of time, and may use the selected equation to forecast the characteristics of the target item. Alternatively, forecasting module 105 may select an equation that corresponds to the best fitness value. In the above example of fitness function FF_{error&quality} in which the forecasting process is attempting to minimize the fitness value, forecasting module may select an equation that has a fitness value that is the minimum amongst all of the fitness values of the candidate equations in population table 600. For example, referring to FIG. 6, if candidate equation 611 is selected, forecasting module 105 may forecast the characteristic value at a future time “t” by using candidate equation 611

$$F ( t ) = {\sum }_{i = 1}^{q} {α}_{i} {ɛ}_{t - i}^{2} .$$

Then, the forecasting process may stop for this item.

In the above embodiment, the forecasting process may include a single evolutionary process 218 that is performed based on the collected historical data over a period of time (T). That is, evolutionary process 218 determines a fitness value of each candidate equation based on a fitness function that assesses the fitness of the candidate equations with respect to the collected historical data over the period of time. Sometimes, when period T is long, evolutionary process 218 may require a large amount of iterations until the convergence criterion is finally satisfied.

Alternatively, in another embodiment, the forecasting process may include an incremental evolution process in order to reduce the amount of iterations. In the incremental evolution process, forecasting module 105 may first partition the collected historical data over period T into a plurality of subsets of historical data over different periods, such as T1, T2, . . . Tn, with T1 being the earliest time period, and Tn being the most recent time period, and then incrementally evolve the candidate equations based on the subsets of historical data.

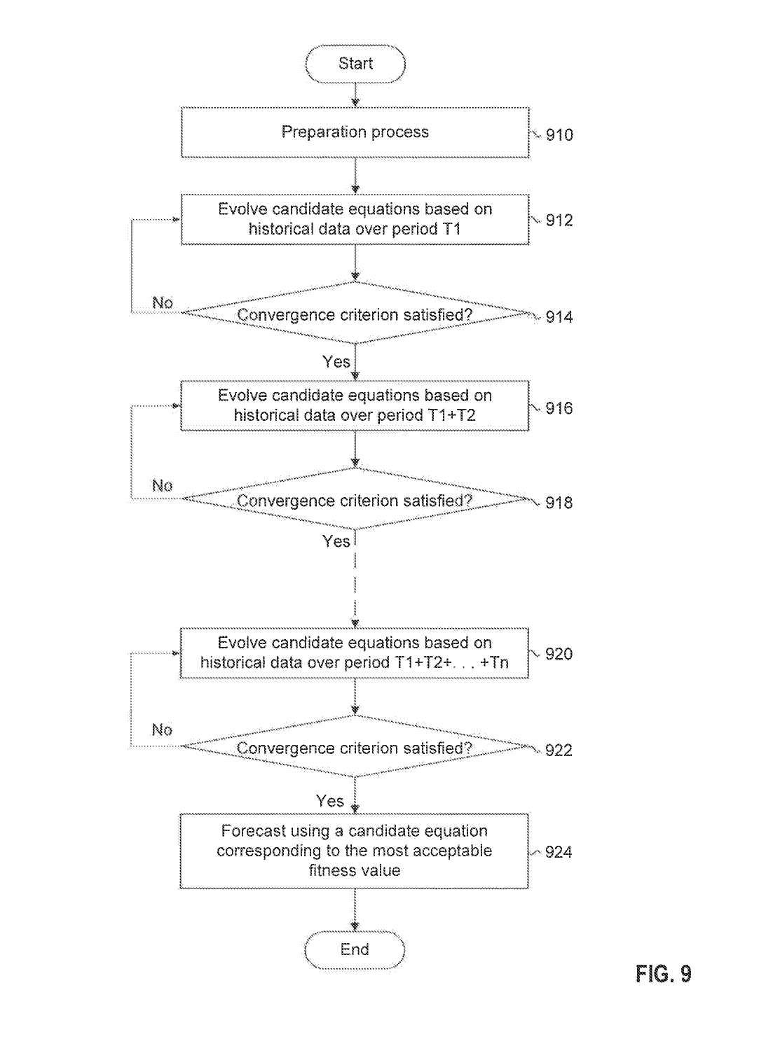

FIG. 9 illustrates a flowchart of an exemplary forecasting process that may include the incremental evolution process, consistent with the disclosed embodiments, As illustrated in FIG. 9, forecasting module 105 may begin with a preparation process (step 910) that may include steps 210, 212, 214, and 216 illustrated in FIG. 2. Preparation process 910 may also include partitioning the historical data collected in step 210 into a plurality of subset of historical data. Following preparation process 910, forecasting module 105 may iteratively evolve the candidate equations prepared in preparation process 910 based on the subset of the historical data over period T1 (step 912), until the convergence criterion is satisfied (step 914). The evolved candidate equations may be saved in population table 600. Then, forecasting module 105 may iteratively evolve the candidate equations in population table 600 based on a combination of the subsets of the historical data over period T1 and period T2 (step 916), until the convergence criterion is satisfied (step 918). Forecasting module 105 may repeat the evolutionary process, each time based on a combination of the previous subsets of the historical data, and the subset of historical data over a more recent period, until all of the subsets of historical. Finally, forecasting module 105 may iteratively evolve the candidate equations based on a combination of the subsets of the historical data over periods T1 through Tn (step 920), until the convergence criterion is satisfied (step 922). Afterwards, forecasting module 105 may forecast the characteristic of the target item by using a candidate equation corresponding to the most acceptable fitness value (step 924).

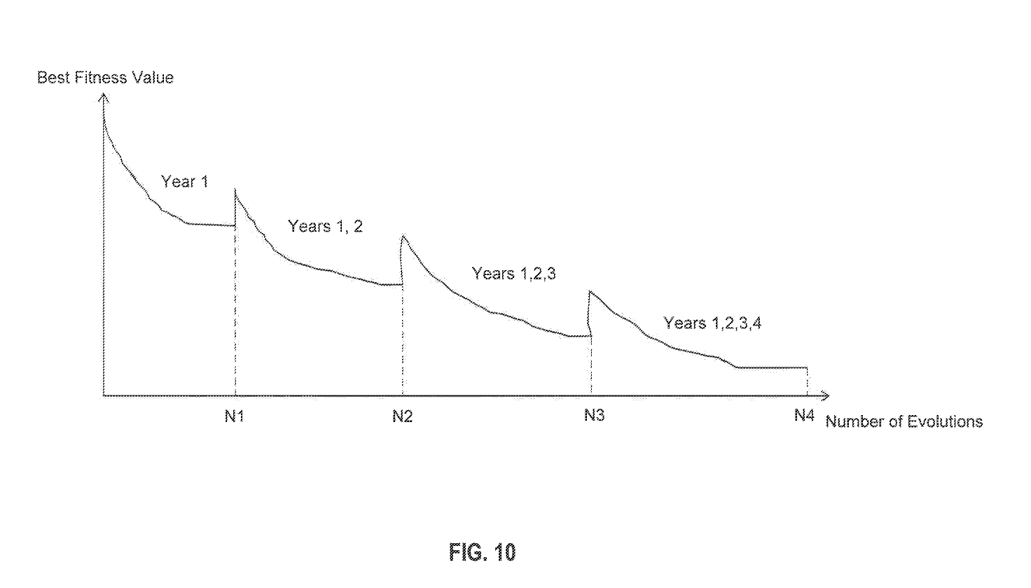

FIG. 10 is a graph that represents best fitness values versus numbers of evolutions, obtained by an incremental evolution process. The incremental evolution process may be performed based on historical data collected over a period of four (4) years, that are partitioned into historical data over Year 1, historical data over Year 2, historical data over Year 3, and historical data over Year 4. The best fitness value may be determined according to the fitness function FF_{error&quality}. The incremental evolution process may first evolve the candidate equations in population table 600 based on historical data over Year 1, such that the best fitness value may gradually decrease and finally converge after a certain number N1, of evolutions. Then, the incremental evolution process may evolve candidate equations obtained after number N1 of evolutions based on the historical data over Year 1 and Year 2, such that the best fitness value may further decrease and finally converge after number N2 of evolutions. Next, the incremental evolution process may evolve candidate equations obtained after number N2 of evolutions based on the historical data over Year 1, Year 2, and Year 3, such that the best fitness value may further decrease and finally converge after number N3 of evolutions. Finally, the incremental evolution process may evolve candidate equations obtained after number N3 of evolutions based on the historical data over Year 1, Year 2, Year 3, and Year 4, such that the best fitness value may further decrease and finally converge after number N4 of evolutions.

As will be evident to those skilled in the art, the embodiment described with reference to FIGS. 9 and 10 presume a uniform weighting of the fitness value over the years of historical data. Clearly a non-uniform weighting of the fitness function could also be applied as appropriate to the application. For instance, the fitness of Year 4 could be weighted more heavily in the evolution process indicated after N3 evolutions, to place more emphasis on near-term performance. In such case, the fitness function may be represented by:

$${FF}_{error \& quality} = c ( a \cdot {FF}_{error 1} + b \cdot {FF}_{quality 1} ) + d ( a \cdot {FF}_{error 2} + b \cdot {FF}_{quality 2} ) + e ( a \cdot {FF}_{error 3} + b \cdot {FF}_{quality 3} ) + f ( a \cdot {FF}_{error 4} + b \cdot {FF}_{quality 4} )$$

where a and b represent the relative weighting values for the the error-based fitness function FFₑᵣᵣₒᵣ and the quality-based fitness function FF_{quality}, and a+b=1; c, d, e, and f represent the relative weighting values for the fitness of the historical data over Year 1, Year 2, Year 3, and Year 4, respectively, and c+d+e+f=1. For example, e=0.1, d=0.15, e=0.25, and f-0.5. Other relative weighting schemes, such as linear or exponential wieghtings will be apparent to those skilled in the art.

### INDUSTRIAL APPLICABILITY

Methods, systems, and articles of manufacture consistent with features related to the disclosed embodiments allow a system to forecast values for a target item based on historical data associated with the target item. These methods and systems may be applied to any tangible and/or non-physical target item. In one embodiment, a target item may represent a product that is manufactured, delivered, and/or maintained by a business entity, such as a manufacturer. Non-limiting examples of a product may include a vehicle, parts of a vehicle, commercial and/or residential appliances, tools, food service products, and any type of product that may be designed, developed, created, generated, manufactured, delivered, and/or stored as inventory.

Methods and systems consistent with certain embodiments implement a genetic algorithm to evolve a plurality of forecasting equations that may be used to produce forecast data for a product. Moreover, methods and systems consistent with certain embodiments implement the genetic algorithm using a fitness function that takes into account one or more business goals of a business, such as profit, RONA, service level, inventory turns, or other business goals.

It will be apparent to those skilled in the art that various modifications and variations can be made to the disclosed forecasting system. Other embodiments will be apparent to those skilled in the art from consideration of the specification and practice of the disclosed forecasting system. It is intended that the specification and examples be considered as exemplary only, with a true scope being indicated by the following claims and their equivalents.

What is claimed is:

1. A computer-implemented method for forecasting characteristics of a target item, comprising:
collecting, by a processor, a plurality of forecasting equations;
decomposing, by the processor, each of the plurality of forecasting equations into one or more building blocks;
creating, by the processor, a population table consisting of a plurality of candidate equations each including one or more of the building blocks;
evolving, by the processor, the candidate equations in the population table by implementing a genetic algorithm based on historical characteristic data of the target item over a period of time until a convergence criterion is satisfied;
selecting an equation from the plurality of candidate equations in the population table that best fits the historical characteristic data over the period of time; and
forecasting the characteristics of the target item by using the selected equation.

2. The method of claim 1, wherein the evolving the candidate equations in the population table by implementing a genetic algorithm based on historical characteristic data of the target item over a period of time, includes:
determining a fitness value for each of the candidate equations based on the historical characteristic data of the target item over the period of time;
eliminating one or more of the plurality of candidate equations in the population table that have fitness values inferior to the other candidate equations; and
adding one or more new candidate equations to the population table by combining two or more of the existing candidate equations.

3. The method of claim 2, wherein the convergence criterion is satisfied when an improvement of a best fitness value over a previous best fitness value falls below a predetermined threshold value,
the best fitness value is selected amongst the fitness values of the candidate equations in the population table after evolution, and
the previous best fitness value is selected amongst the fitness values of the candidate equations in the previous population table before evolution.

4. The method of claim 1, wherein at least one of the candidate equations further includes one or more standard mathematical operators in addition to the one or more building blocks.

5. The method of claim 1, further including:
decomposing each of the building blocks into one or more arithmetic operators, building blocks, and constants; and
encoding each of the candidate equations via a numeric string based on the one or more arithmetic operators, building blocks, and constants.

6. The method of claim 2, further including:
determining the fitness value of each candidate equation based on a combination of an error-based fitness function and a quality-based fitness function,
wherein the error-based fitness function determines how close calculated data values determined by the corresponding candidate equation are to actual values in the historical characteristic data, and
the quality-based fitness function determines a percentage difference for at least one business goal selected from a group consisting of profit, return on net assets, inventory turns, and service level.

7. The method of claim 1, further including:
partitioning the historical characteristic data over the period of time into a plurality of subsets of historical characteristic data; and
incrementally evolving the candidate equations in the population table based on the plurality of subsets of historical characteristic data.

8. The method of claim 7, wherein during the incrementally evolving of the candidate equations in the population table based on the plurality of subsets of historical characteristic data, a fitness of a subset of historical characteristic data over the more recent period of time is weighted more heavily than a fitness of a subset of historical characteristic data over other period of time.

9. The method of claim 1, wherein the evolving the candidate equations in the population table by implementing a genetic algorithm based on historical characteristic data of the target item over a period of time, further includes:
determining both a fitness value and a plurality of business values for each of the candidate equations;
eliminating one or more of the plurality of candidate equations in the population table that have one or more of the business values inferior to the other candidate equations; and
adding one or more new candidate equations to the population table by combining two or more of the existing candidate equations.

10. A system for forecasting characteristics of a target item, comprising:
a processor; and
a memory module configured to store instructions, that, when executed, enable the processor to:
collect a plurality of forecasting equations;
decompose each of the plurality of forecasting equations into one or more building blocks;
create a population table consisting of a plurality of candidate equations each including one or more of the building blocks;
evolve the candidate equations in the population table by implementing a genetic algorithm based on historical characteristic data of the target item over a period of time until a convergence criterion is satisfied;
select an equation from the plurality of candidate equations in the population table that best fits the historical characteristic data over the period of time; and
forecast the characteristics of the target item by using the selected equation.

11. The system of claim 10, wherein the instructions stored in the memory module further enabling the processor to:
determine a fitness value for each of the candidate equations based on the historical characteristic data of the target item over the period of time;
eliminate one or more of the plurality of candidate equations in the population table that have fitness values inferior to the other candidate equations; and
add one or more new candidate equations to the population table by combining two or more of the existing candidate equations.

12. The system of claim 11, wherein the convergence criterion is satisfied when an improvement of a best fitness value over a previous best fitness value falls below a predetermined threshold value,
the best fitness value is selected amongst the fitness values of the candidate equations in the population table after evolution, and
the previous best fitness value is selected amongst the fitness values of the candidate equations in the previous population table before evolution.

13. The system of claim 10, wherein at least one of the candidate equations further includes one or more standard mathematical operators in addition to the one or more building blocks.

14. The system of claim 10, wherein the instructions stored in the memory module further enabling the processor to:
decompose each of the candidate equations into one or more arithmetic operators, building blocks, and constants; and
encode each of the candidate equations via a numeric string based on the one or more arithmetic operators, building blocks, and constants.

15. The system of claim 11, wherein the instructions stored in the memory module further enabling the processor to:
determine the fitness value of each candidate equation based on a combination of an error-based fitness function and a quality-based fitness function,
wherein the error-based fitness function determines how close calculated data values determined by the corresponding candidate equation are to actual values in the historical characteristic data, and
the quality-based fitness function determines a percentage difference for at least one business goal selected from a group consisting of profit, return on net assets, inventory turns, and service level.

16. The system of claim 10, wherein the instructions stored in the memory module further enabling the processor to:
partition the historical characteristic data over the period of time into a plurality of subsets of historical characteristic data; and
incrementally evolve the candidate equations in the population table based on the plurality of subsets of historical characteristic data.

17. The system of claim 16, wherein during the incrementally evolving of the candidate equations in the population table based on the plurality of subsets of historical characteristic data, a fitness of a subset of historical characteristic data over the more recent period of time is weighted more heavily than a fitness of a subset of historical characteristic data over other period of time.

18. The system of claim 10, wherein the evolving the candidate equations in the population table by implementing a genetic algorithm based on historical characteristic data of the target item over a period of time, further includes:
determining both a fitness value and a plurality of business values for each of the candidate equations;
eliminating one or more of the plurality of candidate equations in the population table that have one or more of the business values inferior to the other candidate equations; and
adding one or more new candidate equations to the population table by combining two or more of the existing candidate equations.

19. A non-transitory computer-readable storage device storing instructions for forecasting characteristics of a target item, the instructions causing one or more computer processors to perform operations comprising:
collecting a plurality of forecasting equations;
decomposing each of the plurality of forecasting equations into one or more building blocks;
creating a population table consisting of a plurality of candidate equations each including one or more of the building blocks;
evolving the candidate equations in the population table by implementing a genetic algorithm based on historical characteristic data of the target item over a period of time until a convergence criterion is satisfied;
selecting an equation from the plurality of candidate equations in the population table that best fits the historical characteristic data over the period of time; and
forecasting the characteristics of the target item by using the selected equation.

20. The computer-readable storage device of claim 19, the instructions further causing the one or more computer processors to perform operations including:
determining a fitness value for each of the candidate equations based on the historical characteristic data of the target item over the period of time;
eliminating one or more of the plurality of candidate equations in the population table that have fitness values inferior to the other candidate equations; and
adding one or more new candidate equations to the population table by combining two or more of the existing candidate equations.
